(19) United States
(12) Patent Application Publication
(10) Pub. No.: US 2012/0111837 A1
(43) Pub. Date: May 10, 2012

(54) IN-SERVICE WELD REPAIRS USING METAL ARC WELDING UNDER OIL (MAWUO) OF PIPELINES, TANKS, AND VESSELS

(76) Inventors: Hamad H. Al-Mostaneer, Dhahran (SA); David L. Olson, Golden, CO (US)

(21) Appl. No.: 13/293,959

(22) Filed: Nov. 10, 2011

Related U.S. Application Data
(60) Provisional application No. 61/412,295, filed on Nov. 10, 2010.

(51) Int. Cl. B23K 9/18; B23K 9/10

(52) U.S. Cl. 219/73; 219/130.1

(57) ABSTRACT

Apparatus and methods of repairing an in-service pipeline, tank, and/or vessel are provided. Generally, a metal arc welding under oil process employing an automated metal arc welding setup with a continuous wire feed is utilized. The process may be used in connection with a smart pig to perform in-situ internal repairs of in-service pipelines, tanks, and/or vessels. For example, a pipeline pig or other device is contemplated that employs an internal power supply, a navigation system, and a metal arc welding under oil system that is able to travel vast distances within a pipeline to reach pipeline segments that are either buried underground, under highways, or underwater making access very difficult. Once at its desired location, the pipeline pig performs in-situ welding or other internal repairs to the in-service pipeline. The disclosed apparatus and methods provide great flexibility to the repair of pipelines, tanks, and/or vessels.

This application claims the benefit of U.S. Provisional Patent Application Ser. No. 61/412,295, filed Nov. 10, 2010, the entire disclosure of which is incorporated by reference herein.

### TECHNICAL FIELD

Embodiments of the present invention generally relate to metal arc welding and, more specifically, to weld repairs of in-service pipelines, tanks, and vessels.

### BACKGROUND

In the oil and gas industry, oil and gas reserves often are located in remote areas far from potential markets. Thus, pipelines, tanks, and vessels are used to store and transport oil and gas products from oil and/or gas wells to processing facilities, pump stations, storage facilities, and the end customer. Because of the importance of these storage and transportation devices, downtime needs to be minimized. Accordingly, detection and correction of defects including external corrosion, internal corrosion, construction flaws, service-induced cracking, and mechanical damage in a cost-efficient and timely manner is desired. Embodiments of the present invention relate to the in-situ detection and repair of pipelines; however, the problems and various embodiments of the present invention discussed herein are also generally applicable to tanks and vessels that store and/or transport hydrocarbons and non-volatile liquids.

Generally, to detect a defect in a pipeline, a pigging process utilizing a pipeline “pig” is employed. “Pigging” refers to the practice of using a device, commonly referred to as a pig, to perform various internal operations on a pipeline without stopping the flow of the product in the pipeline. Common uses include scraping the interior of the pipeline to remove paraffin wax and hydrates, which can severely restrict the flow diameter of the pipeline. Smart pigs, also referred to as intelligent pigs, are used to inspect the pipeline with sensors and record the data for later analysis. The pigs may utilize technologies including magnetic flux leakage, ultrasonics, electromagnetic acoustic transducers, calipers, and acoustic resonance to inspect the pipeline. In general, inspection is accomplished by inserting a smart pig into a pig launcher, i.e., a funnel shaped “Y” section of the pipeline. The launcher is then closed and pressure is used to propel the pipeline pig down the pipe until it reaches a receiving trap. In some configurations, the pipeline pig may utilize an onboard pump or wheels for propulsion.

The smart pig collects various forms of data as the pig travels through the pipeline, including the pipe thickness, while not interrupting production. Smart pigs are highly sophisticated instruments that vary in technology and complexity by their intended use. Power for the electronics carried by the smart pigs is provided by onboard batteries, and data may be collected and stored by various means ranging from analog tape in a reel-to-reel format, digital tape, or solid state memory. Data storage is necessary because, during the pigging run, the smart pig is unable to directly communicate with the outside world due to the pig's distance underground or underwater and/or the pipe material. For example, steel pipelines effectively prevent any reliable radio communications outside the pipe. Accordingly, smart pigs utilize internal means, including gyroscope-assisted tilt sensors, odometers, and other technologies, to record the pig's location during the trip. Surface instruments may provide location verification. Examples of pigs are discussed in U.S. Pat. Nos. 4,769,598; 5,080,020; 5,205,048; 5,208,936; 6,070,285; 6,098,231; 6,190,090; 6,370,721; 6,381,797; 6,415,722; 6,538,431; 6,722,442; 6,769,321; 6,874,193; 6,944,902; 7,000,280; 7,406,738; 7,614,109; 7,617,558; 7,827,646; 7,975,342; and U.S. Patent Publication Nos. 2005/0072237; 2006/0064829; 2009/0188059; 2009/0304542; 2009/0307857; 2010/0000037; 2010/0031461; 2010/0192317; and 2011/0061681; the entire disclosures of which are hereby incorporated by reference.

After a pigging run has been completed, positional data gathered by the pig is combined with the pipeline evaluation data (corrosion, cracks, etc) to provide a location-specific defect map and characterization. In other words, the combined data will tell the operator the location and type and size of each pipe defect. This is used to judge the severity of the defect and help repair crews locate and repair the defect. By evaluating the rate of change of a particular defect over several years, proactive plans can be made to repair the pipeline before any leakage or environmental damage occurs.

Various apparatus and methods have been utilized to repair pipeline defects, including external and internal methods. An example of an external sleeve-repair method is discussed in “Development of Internal (Trenchless) Repair Technology for Gas Transmission Pipelines” by Harwig, et al., which is incorporated by reference in its entirety herein. Harwig discloses that repair sleeves can be utilized to reinforce an area associated with corrosion damage, thus preventing corrosion-related rupture of a pipeline. As discussed in Harwig, defects oriented in the longitudinal direction of the pipeline have a tendency to cause the pipeline to fail from hoop stress (due to pressure loading) and must be reinforced in the circumferential direction. Defects oriented in the circumferential direction of the pipeline have a tendency to cause the pipeline to fail from axial stresses (e.g., pipeline settlement) and must be reinforced in the longitudinal direction. Thus, one commonly used method for repair of transmission pipelines is the installation of welded full-encirclement external steel repair sleeves. These sleeves resist hoop stress and, if the ends are welded to the pipeline, can resist axial stresses.

Another external pipeline repair method includes hot-tapping. “Hot-tapping” is a process wherein holes are cut into a pipe, a tank, or any pressurized vessel, without interrupting system function and with no release of oil or gas. Hot-tapping permits the insertion of devices into the flow stream, e.g., weld fixtures. Hot-tapping is costly and is associated with operational issues known by those of skill in the art. For example, cooling rates associated with welding an in-service pipeline are increased because the flowing contents quickly remove heat from the pipe wall. Increased cooling rates promote the formation of non-desirable heat-affected zone microstructures that render welds susceptible to hydrogen and sulfide-stress cracking.

Yet another external pipeline repair method includes direct deposition of weld metal. Pipeline repair by direct deposition of weld metal, or weld deposition repair, is an existing technology that can be applied directly to the area of wall loss (e.g., external repair of external wall loss) or to the side opposite the wall loss (e.g., external repair of internal wall loss).

Sometimes external pipeline repair is difficult or impossible as the pipeline is buried, located under bodies of water, in difficult soil conditions, under highways, under congested intersections, etc. Accordingly, internal repair methods and apparatus have been developed. Existing internal repair methods typically require the pipeline service to be shutdown and the fluid to be evacuated before a repair can begin, which is disadvantageous. For example, liners that are commonly used for the internal repair of other types of pipelines (e.g., gas distribution lines, sewers, water mains, etc.) are potentially applicable to internal repair of transmission pipelines, including sectional liners, cured-in-place liners, and fold-and-formed liners. The application of liners, however, often requires that the pipeline be taken out-of-service or that hot-tapping be used.

Another internal pipeline repair method that may be used to repair internal defects in an out-of-service pipeline is remote welding. Remote welding was developed primarily for the nuclear power industry, although working devices have been built for other applications. For example, beginning in 1985, Osaka Gas developed remote robotic equipment for repair of flaws in the root area of welds in out-of-service gas transmission lines. A self-propelled robot performed a gas metal arc welding (“GMAW”) process that is well known in the art wherein the torch travel path is programmed prior to welding. Welding filler metal was carried onboard the robot, while shielding gas, power, and control was supplied to the robot via an umbilical cable. Inspection of completed repairs was performed visually using video cameras located on the robot. Due to the umbilical cable, the robot's working range was limited to 500 ft. from the pipeline entry point. Additionally, use of the robot was limited to out-of-service pipeline repairs because of safety, performance, and design issues.

Based on the limitations of the prior art methods of repairing pipeline defects, there is a significant need for methods and apparatus for internally repairing an in-service pipeline using a robust welding process. The important characteristics of a useful internal weld deposition repair system include the ability to operate at long ranges from the pipe entry point (i.e., 2,000+ feet), to transverse bends and miters, to operate while the pipeline is in service, and to generate acceptable welds in accordance with the American Welding Society (“AWS”) standards.

The following references and materials relate to this subject, and are incorporated by reference in their entirety herein:

“Underwater wet welding of higher strength offshore steels,” S. Ibarra, D. L. Olson and C. E. Grubbs, Offshore Technology Conference, Texas, 1989;

“Designing shield metal arc consumables for underwater wet welding in offshore applications,” A. Sanchez-Osio, S. Liu, D. L. Olson and S. Ibarra, Transaction of the ASME, Vol. 117, August 1995;

“Porosity variation along multipass underwater wet welds and its influence on mechanical properties,” Ezequiel Caires Pereira Pessoa et al., Journal of Materials Processing Technology 179, pp 239-243, 2006;

“Influence of pressure and temperature on diffusion of oxygen in crude oil,” V. E. Gal'tsev and V. N. Mitin, A. P. Krylov All Union Oil and Gas Scientific Research Institute, No. 6, pp 23-24, June 1993;

“The physical and chemical behavior of steel welding consumables,” D. L. Olson and S. Liu, Trends in Welding Research, Proceedings of the 4th International Conference, 5-8 Jun. 1995;

“Microstructure-property relationships in pearlitic eutectoid and hypereutectoid carbon steels,” E. M. Taleff, J. J Lewandowski and B. Pourladian, Minerals, Metals and Materials Society, JOM, pp 25-30, July 2002;

“Cast iron welding materials,” D. L. Olson and A. M. Davila, European Patent EP0038820 and West Germany Patent P3071827.5, Nov. 12, 1986;

“Cast iron welding electrodes,” D. L. Olson and A. Davila Marques, U.S. Pat. No. 4,726,854, Feb. 23, 1988;

“The fundamentals of weld metal pore formation,” R. E Trevisan, D. D. Schwemmer and D. L. Olson, Welding: Theory and Practice, Elsevier Science Publisher B.V., 1990;

“Effect of welding variables and solidification substructure on weld metal porosity,” J. E Ramirez, B. Han and S. Liu, Metallurgical and Materials Transaction, Vol. 25A, 1994; and

“Weld bead tempering of the heat-affected zone,” K. Olsen, D. L Olson and N. Christensen, Scandinavian Journal of Metallurgy 11, pp 163-168, 1982.

### SUMMARY

Embodiments of the present invention are generally directed to methods and apparatus for the in-situ repair of defects in an in-service pipeline, tank, and/or vessel. In general, the methods and apparatus discussed herein utilize a metal arc welding under oil (“MAWUO”) process to repair an in-service pipeline, tank, and/or vessel in accordance with the AWS criteria for an acceptable weldment. Embodiments of the present invention also are applicable to repairs performed under other non-volatile liquids.

It is an aspect of the present invention to provide an arc welding process for repairing an in-service pipeline, tank, and/or vessel that utilizes an automated welding process. In some embodiments, a MAWUO process utilizes a continuous wire feed, a constant voltage, and inductance control to generate an acceptable weldment. In these embodiments, a welding power supply maintains an arc between a consumable wire electrode and a workpiece all under crude oil, thereby generating the heat required for welding. A wire feed continuously feeds the consumable wire electrode into a weld pool to repair the defect, while the inductance is adjusted to improve the welding behavior.

It is another aspect of the present invention to provide an arc welding process for repairing an in-service pipeline, tank, and/or vessel that minimizes the equipment necessary to generate an acceptable weldment. In some embodiments, the welding process generates a shielding gas from fractionated hydrocarbons, and an external shielding gas agent is not utilized. Accordingly, in some embodiments, methods and apparatus disclosed herein are not burdened by carrying a shielding gas and its associated equipment.

It is another aspect of the present invention to provide an arc welding process for repairing an in-service pipeline, tank, and/or vessel that minimizes the debris generated by the welding process. In some embodiments, a consumable wire electrode comprises a solid wire substantially void of flux. In these embodiments, the welding process generates a weldment with an acceptable microstructure and mechanical properties, including machinability, low porosity, and sufficient hardness, without the use of flux. Thus, in some embodiments, apparatus employing the welding process disclosed herein are not burdened with disposing of the flux generated by conventional arc welding processes.

It is yet another aspect of the present invention to provide an arc welding process for repairing an in-service pipeline, tank, and/or vessel that produces a weldment with properties comparable to the workpiece. In some embodiments, the welding process utilizes an electrode comprising nickel and/or manganese. In these embodiments, adding nickel and/or manganese in sufficiently high concentrations to the electrode substantially eliminates the bcc ferrite-iron phase and replaces it with the austenite-phase. Thus, utilizing nickel and/or manganese in sufficiently high concentrations in the electrode reduces the hardness and porosity of the weldment to levels comparable to the workpiece, e.g., the pipeline, tank, and/or vessel wall. In some embodiments, the wire electrode comprises an iron-nickel alloy having a nickel content of at least 50 percent of the total wire chemistry by weight. For example, in some embodiments, the wire electrode comprises a nickel content of between about 55 to 70 percent of the total wire chemistry by weight. Further, in some embodiments, the wire electrode comprises a nickel content of about 95 percent of the total wire chemistry by weight. In some embodiments, the wire electrode comprises an alloy comprising iron, nickel, and manganese. For example, in some embodiments, the wire electrode comprises between about 15 to 25 percent nickel and between about 15 to 25 percent manganese of the total wire chemistry by weight. In one embodiment, the sum of the nickel and manganese content comprises approximately 40 percent of the total wire chemistry by weight. In a specific embodiment, the wire electrode comprises about 20 percent nickel, about 20 percent manganese, and about 60 percent iron. The aforementioned wire electrode compositions result in a weld deposit that has a thermal expansion coefficient that is compatible with steel, thus reducing cracking of the filler metal and/or steel workpiece.

It is another aspect of the present invention to provide a pipeline pig for performing in-service pipeline repairs using a weld deposition repair system. In some embodiments, a pipeline pig is utilized that includes welding consumables, a welding torch, a power supply, and a computer system. The pig may be propelled or transported within the pipeline by an onboard pump, controllable wheels, electric line or wire-line, pressure differentials within the pipeline, and/or other means known in the art. Cameras and lights may also be included to assist in positioning and assessment of the repair.

It is yet another aspect of the present invention to provide a repair system that includes an inspection capability for detecting flaws, a grinding capability for cleaning and preparing a weld joint, a welding capability for generating a weld bead to repair a detected flaw, and a machining capability for surfacing a weld into alignment with the workpiece surface. In some embodiments, the inspection, grinding, welding, and machining capabilities are associated with a rotatable sleeve.

The methods and apparatus disclosed herein are generally described in connection with the in-situ repairs of a pipeline. However, the disclosure is for illustrative purposes and should not be deemed as limiting. Rather, the embodiments disclosed herein are applicable to tanks, vessels, and other devices that retain similar types of fluid as discussed herein, whether the fluid is in a dynamic or static condition.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” or “an”, “one or more”, and “at least one” can be used interchangeably herein.

The use of “including,” “comprising,” or “having”, and variations thereof, herein is meant to encompass the items listed thereafter and equivalents thereof as well as additional items. Accordingly, the terms “including,” “comprising,” or “having”, and variations thereof, can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The Summary is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. Embodiments of the present invention are set forth in various levels of detail in the Summary as well as in the attached drawings and the Detailed Description and no limitation as to the scope of the present invention is intended by either the inclusion or non-inclusion of elements, components, etc. in this Summary. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a schematic of a MAWUO process;

FIG. 2 is another schematic of the MAWUO process shown in FIG. 1;

FIG. 3 is a schematic of a pipeline pig employed by some embodiments of the present invention;

FIG. 4 is a perspective view of another pipeline pig employed by some embodiments of the present invention;

FIG. 5 is a side elevation view of the rotatable sleeve shown in FIG. 4;

FIG. 6 is a perspective view of the pipeline-pig body shown in FIG. 4;

FIG. 7 is a side elevation view of the pipeline-pig body of FIG. 6;

FIG. 8 is a perspective view of the pipeline pig of FIG. 4 partially disposed within a segment of pipe;

FIG. 9 is a side elevation view of the pipeline pig and pipe shown in FIG. 8; and

FIG. 10 is a schematic of a test fixture used to validate embodiments of a MAWUO welding process.

To assist in the understanding of some embodiments of the present invention, the following list of components and associated numbering found in the drawings is provided herein:

| # | Component |
|---|---|
| 2 | Welding gun |
| 6 | Workpiece |
| 10 | Wire feed unit |
| 14 | Wire electrode |
| 16 | Reel |
| 20 | Power Supply |
| 22 | Cabling |
| 24 | Oil |
| 26 | Contact tube |
| 28 | Arc |
| 30 | Oil vapor bubble |
| 32 | Molten weld pool |
| 34 | Molten droplet |
| 36 | Weld metal |
| 38 | Electrode tip |
| 42 | Pipeline pig |
| 44 | Pipe |
| 46 | Outer housing |
| 50 | Computer system |
| 54 | Power supply |
| 58 | Pump |
| 62 | Wheels |
| 74 | Pipeline pig |
| 78 | Wheels |
| 82 | Rotatable sleeve |
| 86 | Body |
| 90 | Pivotable lever |
| 94 | Nondestructive evaluation tool |
| 98 | Grinding tool |
| 102 | Machining tool |
| 106 | Welding tool |
| 110 | Box |
| 114 | Lugs |
| 118 | Openings |
| 122 | Cavity |
| 126 | Central aperture |
| 202 | Test fixture |
| 206 | Tank |
| 210 | Crude oil |
| 214 | Test sample |
| 218 | Wire feeder |
| 222 | Wire electrode |
| 226 | Contact tube |
| 230 | Tip |
| 234 | Moving arm |
| 238 | Linear actuator |
| 242 | Motor driver |
| 246 | Racks |

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

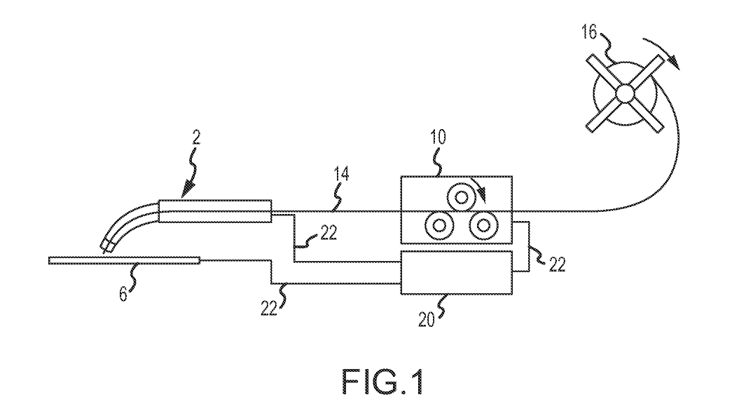

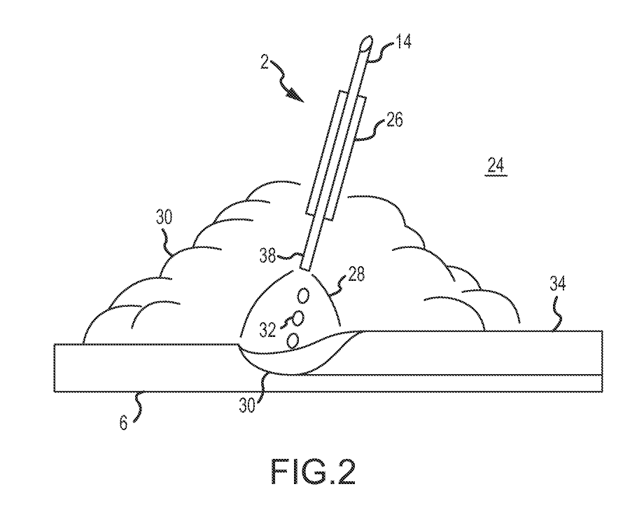

FIGS. 1-2 depict an embodiment of an arc welding technique, referred to herein as MAWUO, for use in hydrocarbon oil environments. Generally, MAWUO is a process that utilizes an arc maintained between a wire electrode and a workpiece to generate the heat required for depositing material on the workpiece. In certain embodiments, the equipment utilized in MAWUO includes a welding gun, a wire electrode, a wire feed unit, and a welding power supply. Shielding gas and flux are not required to perform MAWUO.

Referring to FIG. 1, a welding gun 2 is provided for welding a workpiece 6. The welding gun 2 may be any suitable gun or torch used to carry out embodiments of the present invention. As depicted, a wire feed unit 10 draws a consumable wire electrode 14 from a reel 16 and continuously feeds the wire electrode 14 through the welding gun 2 into an arc formed between the consumable wire electrode 14 and the workpiece 6. The wire feed unit 10 includes a feed roll and a drive motor to feed the wire electrode 14 at the speeds necessary to achieve the desired deposition rates.

As illustrated in FIG. 1, a power supply 20 supplies power to the wire feed unit 10 and the welding gun 2 through cabling 22. A contact tube is connected to the welding gun 2 and supplies power to the wire electrode 14. In certain embodiments, the power supply 20 is voltage controlled to provide a constant voltage to the wire electrode 14. To complete the deposition circuit, the workpiece 6 is connected to a ground in common with the power supply ground through cabling 22.

Although not depicted, electrode selection influences the mechanical properties of the weld and is a factor of weld quality. In general, the finished weld metal should have mechanical properties similar to those of the base material with minimal defects, including discontinuities, entrained contaminants, or porosity within the weld. Generally, the consumable wire electrode may be composed of a suitable metal composition appropriate for the particular welding application. As discussed previously, in some embodiments, the consumable wire electrode is a solid wire composed of an iron alloy with nickel and/or manganese. For example, in some embodiments, the consumable wire electrode comprises an iron-nickel alloy having a nickel content of at least 55 percent of the total wire chemistry by weight. In some of these embodiments, electrode wires with a classification of ENiFe-2 may be utilized to generate acceptable weldments.

In operation, an arc is established between the consumable wire electrode 14 and the workpiece 6 by energizing the power supply 20 and feeding the electrode into direct contact with the workpiece 6. The arc voltage between the electrode 14 and the workpiece 6 is kept substantially constant during the welding process, which means that the arc voltage varies by not more than five percent from the set point during the welding process. The arc voltage setpoint is determined based on the chosen metal transfer mode. The substantially constant voltage allows for a self-regulating welding condition in that as the arc length varies during welding, the wire melt off rate also varies to keep the arc voltage substantially constant. This allows for stable welding conditions to be maintained with uniform weld penetration and bead shape. The consumable wire electrode is fed through a welding gun contact tube into the arc and metal is transferred from the wire electrode 14 to the workpiece 6. In certain embodiments, the linear actuator speed is within the range of about 2 to 8 inches per minute, the arc voltage is within the range of about 15 to 40 volts, the current varies within the range of about 75 to 300 amperes, and the wire feed rate is within the range of about 200 to 450 inches per minute. In some embodiments, the linear actuator speed is about 7.2 inches per minute, the arc voltage is between about 25 to 38 volts, and the wire feed rate is between about 200 to 400 inches per minute.

Referring to FIG. 2, another view of the arc welding technique depicted in FIG. 1 is provided. As depicted in FIG. 2, a welding gun 2 and a workpiece 6 are disposed in oil 24, and the direction of welding is proceeding from right to left. In some configurations, the oil comprises crude oil. As illustrated, the electrode wire is being fed through a contact tube 26 towards the workpiece 6, and an arc 28 has been formed between the wire electrode 14 and the workpiece 6. The arc 28 vaporizes the oil 24 and creates an oil vapor bubble 30 that shields the arc 28 from the hydrocarbon fluid and protects the molten weld pool 26 from fusion defects, porosity, and weld metal embrittlement. As the arc 28 moves, it carries the oil vapor bubble 30 along with it. The arc 28 also generates heat, which in turn melts the wire electrode 14 for deposition to the molten weld pool 32. As illustrated in FIG. 2, molten droplets 34 are being transferred from the wire electrode 14 to the molten weld pool 32. As the arc progresses along the workpiece 6, the molten weld pool 32 cools, thus solidifying into a weld metal 36. To improve welding behavior, inductance control can be adjusted to maximum inductance in order to manage short-circuiting current surge and violent transfer of material from the wire electrode 14 to the molten weld pool 32. Inductance control also assists with arc starts while welding.

Gradual ionization of the oil medium 6 between the electrode 14 and metal workpiece 6 sustains and stabilizes the arc 28. The arc 28 generates heat, which produces a molten weld pool 32 and forms molten droplets 34 at the tip of the electrode 14 for deposition into the molten weld pool 32. Like any other arc fusion welding process, including GMAW, the pendant molten metal droplet at the electrode tip 38 is transferred by one of the three major transfer modes: short-circuiting, globular, or spray depending on the voltage and the wire feed rate.

Within the arc plasma region 28, ionization of the different chemical species of the hydrocarbon 6 takes place. Outside of the arc plasma region 28, hydrocarbons with lower boiling temperature readily vaporize while hydrocarbons with higher boiling temperature only vaporize at a distance closer to the arc plasma region 28. Additionally, larger hydrocarbon molecules undergo decomposition into smaller molecules in the outskirts of the oil vapor bubble 30, while smaller hydrocarbon chains generally require higher temperatures for their break up and thus decompose in regions closer to the arc to result in gases including methane (CH₄) and carbon monoxide (CO). Typically, liquid hydrocarbon exists outside of the oil vapor bubble 30.

As illustrated in FIGS. 1 and 2, in some embodiments, no external shielding agent or flux is used. Rather, shielding is generated from fractionated hydrocarbons under the arc plasma region 28. Additionally, flux is not utilized in an effort to minimize the creation of contaminants, which adversely affects the quality of the hydrocarbons in an in-service pipeline, tank, or vessel.

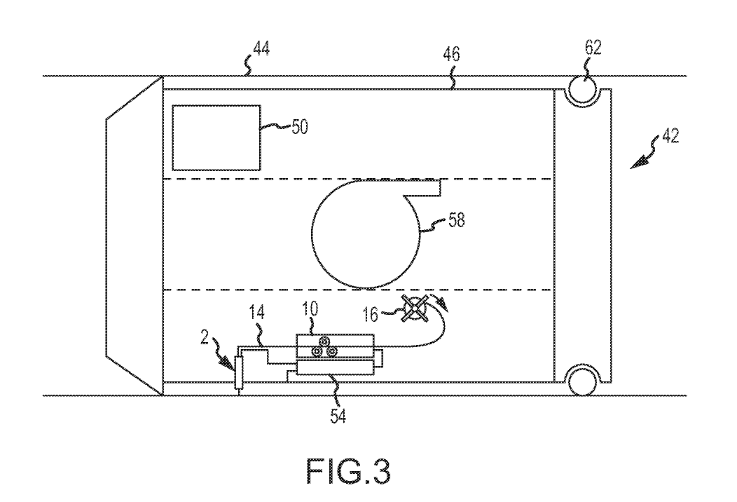

Referring to FIG. 3, an embodiment of a pipeline pig 42 used to perform MAWUO is illustrated. As depicted, the smart pig 42 is disposed within a pipe 44 and includes an outer housing 46 that houses a computer system 50, a power supply 54, and a welding tool for repairing a defect in a pipeline. The computer system 50 includes a memory, a processor, and a navigation system. The welding tool includes a welding gun 2, a wire feed unit 10, a wire electrode 14, and a reel 16, as discussed above in connection with FIG. 1. In some embodiments of the present invention, the welding gun 2 is at least partially positioned outside of the housing and is able to move in three dimensions. For example, linear actuators may be utilized to achieve the directional movement. Additionally, the pig may be maneuverable to accommodate translational and rotational movement within a pipeline to assist in welding a defected section of pipe. The power supply 54 powers the welding gun 2 and the computer system 50 and, in some instances, a pump 58. More specifically, a pump 58 may be provided that receives hydrocarbons via a pump inlet, accelerates those hydrocarbons, and expels the accelerated hydrocarbons from the pump outlet to provide thrust. Wheels 62 also may be employed along the outer diameter of the pipeline pig 42 to help maintain its radial position within the pipeline, for locational control, and/or for propulsion if the wheels are driven. Those with skill in the art will appreciate that additional features, including cameras or other monitoring devices, may be employed without departing from the scope of the invention.

In operation, the pipeline pig of one embodiment of the present invention is sent down a pipeline that has a pipe defect. The defect may be located by a separate inspection pig, or a pig with welding capabilities may include onboard equipment that identifies the location of cracks, leaks, and other possible pipe defects. Once a defect is located, a pig with onboard welding capabilities is sent to the identified location to repair the identified defects. The computer system 50 controls the movement of the pig 42 through the pipeline. For example, the computer system 50 can store the location of a defect identified in the pipeline and then use those coordinates to control the pig's propulsion means to selectively position the pig in the pipeline to allow the welding tool to repair the identified defect. Propulsion means include an onboard pump, controllable wheels, and other means known in the art. Once at the desired location, the welding tool repairs the defect by depositing weld material onto the pipe. After the repair is completed, onboard equipment verifies that the pipe defect has been fixed. The pipeline pig is then returned to a pig catcher for retrieval. Alternatively, a second diagnostic pig can be run to determine the effectiveness of the repair.

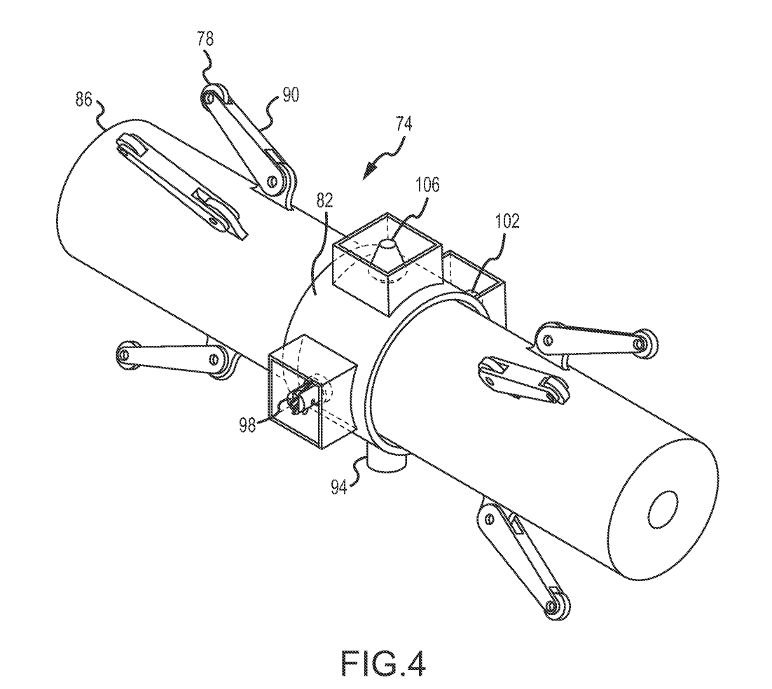

Referring to FIG. 4, another embodiment of a pipeline pig 74 used to perform MAWUO is illustrated. The pipeline pig 74 includes wheels 78 and a rotatable sleeve 82 coupled to a body 86. A pivotable lever 90 connects the wheels 78 to the body 86, and the levers 90 are biased outwardly to bring the wheels 78 into engagement with the inside wall of the pipeline. As such, the wheels 78 abut against the inside wall of the pipe when the pig 74 is moving along the pipe to guide the pig 74 through the pipe. Additionally, the wheels 78 may cause the body 86 to be positioned on or near the center axis of the pipe.

The pig 74 may be driven through the pipeline under its own power. For example, the wheels 78 may be controllable and/or a pump may be used to propel the pig 74 through the pipeline. Alternatively, the pig 74 may be driven through the pipeline due to a pressure differential of the product within the pipeline. For example, the pig 74 may include seals to abut against the internal surface of the pipe and act as a pressure surface for driving the pig 74 through the pipe. Alternatively, the pig may be pulled through the pipe with some form of a slickline or electric line.

As depicted in FIG. 4, a rotatable sleeve 82 is disposed on the circumference of the body 86. In some embodiments, the rotatable sleeve 82 includes a nondestructive evaluation tool 94, a grinding tool 98, a machining tool 102, and a welding tool 106. The nondestructive evaluation tool 94 includes sensors which can detect the properties of the pipe, changes in magnetic flux paths, irregularities, etc. and thus provide an indication of the presence and size of pipe defects. For example, ultrasound or magnetic resonance measurements can be performed to determine the integrity of the pipeline wall. The grinding tool 98 cleans the defined flaw or crack area before welding. Additionally, it may be necessary to clean the wall before inspecting the integrity of the pipeline wall. The grinding tool 98 may be in the form of brushes or scrapers adapted to remove deposits like mineral salts, wax, or oxides from the pipe wall. The machining tool 102 may be provided to machine a weld produced by the welding tool 106 to bring the weld parallel to the surface of the inside wall of the pipeline, thereby creating a smooth transition between the pipe and the weld material.

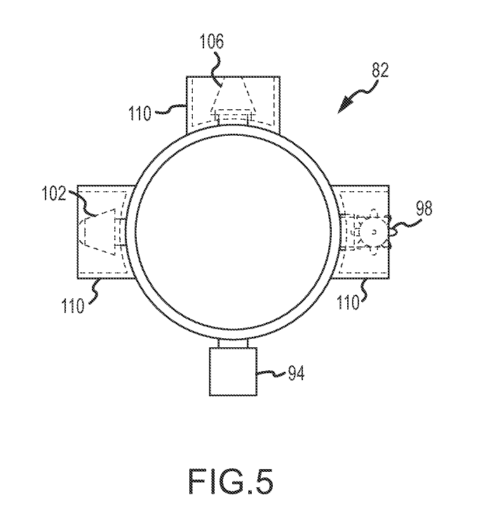

Referring to FIG. 5, a side elevation view of an embodiment of the rotatable sleeve 82 is depicted. As shown, a nondestructive evaluation tool 94, a grinding tool 98, a machining tool 102, and a welding tool 106 are fixed on the rotatable sleeve 82. The grinding tool 98, the machining tool 102, and the welding tool 106 are surrounded with boxes 110 to collect any debris generated by the rotatable sleeve 82. For example, any spattered droplets from welding and flakes or debris from grinding and/or machining are collected in the surrounding box 110 and sucked with a pump into debris holes formed in the rotatable sleeve 82 that are designed for each of the grinding, machining, and welding tools. The box 110 surrounding the welding tool 106 also provides a static welding environment and isolation from the rest of the pipeline fluid for improving the weld environment and safety during the welding process. By fixing the tools on a rotating sleeve, embodiments of the in-situ repairing method provide more flexibility for the different tools to alternate during the repairing process. For example, the nondestructive evaluation tool may be utilized first to detect a defect in the pipe wall. After detection, the rotating sleeve 78 selectively rotates the grinding tool 98 into position to clean the affected area. Then, the rotating sleeve 78 selectively rotates the welding tool 106 into position to weld the affected area. Finally, the rotating sleeve 78 selectively rotates the machining tool 102 into position to machine the weld to finish the repairing process.

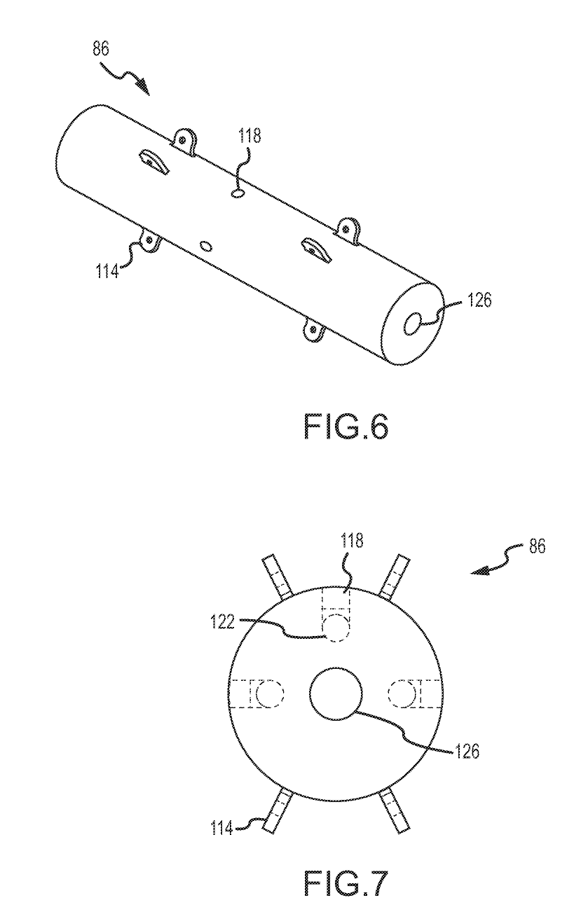

Referring to FIGS. 6-7, a pig body 86 according to an embodiment of the present invention is depicted. As shown, the body 86 has lugs 114 for interconnection with pivotable levers, openings 118 provide a flow path for debris to be stored in a cavity 122 formed within the body 86, and a central aperture 126 provides a flow path for hydrocarbons to flow through the body 86. As illustrated, three openings 118 are provided, and each opening 118 is associated with a cavity 122 disposed within the body 86. In some configurations, only one opening 118 and associated cavity 122 is provided. In certain embodiments, the opening 118 is in fluid communication with the debris holes formed in the rotatable sleeve 82 through an annular groove formed in the outer circumference of the body 86 or in the inner circumference of the rotatable sleeve 82. In operation, an internal pump suctions debris into the cavity 122 to prevent the debris from contaminating the hydrocarbons flowing in the pipeline. It is contemplated that the internal cavity 122 may be associated with a filter screen and an outlet opening to allow the suctioned hydrocarbons to flow out of the cavity while entrapping the debris in the cavity 122.

The body 86 provides a flame proof and explosion proof environment for electrical equipment, which is sealed from the interior of the pipeline. Additionally, the body 86 may contain the instrumentation for recording data and a battery for powering the pig and associated instrumentation. In some embodiments, the internal structure of the pig 74 may be conventional and the rotatable sleeve 82 may include the equipment necessary to operate the tools. For example, in some configurations, a reel, a wire electrode, a wire feed unit, a welding power supply, and a welding gun are disposed on or within the sleeve 82.

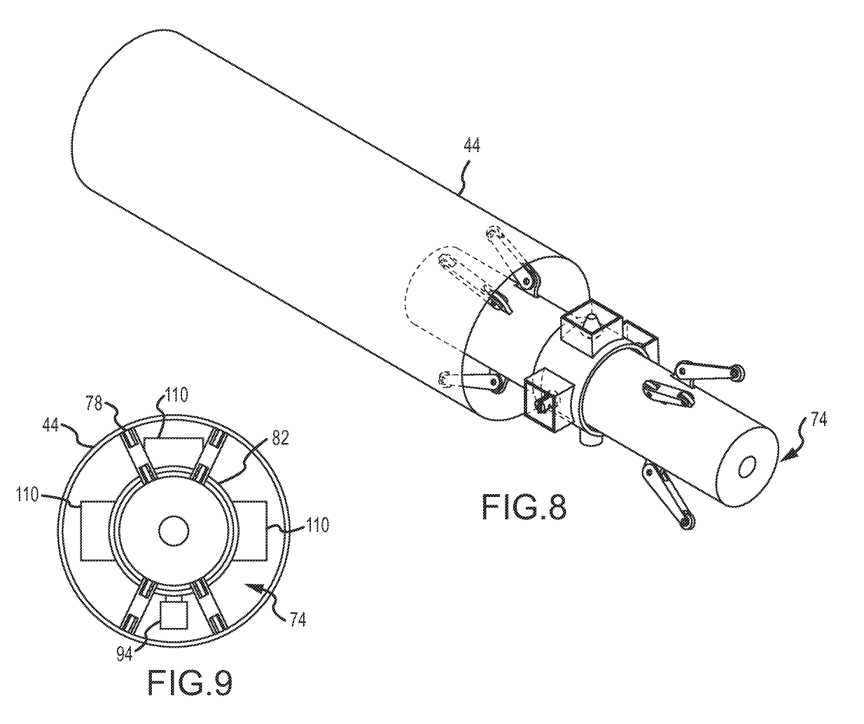

Referring to FIGS. 8-9, a pig 74 is partially disposed within a section of pipe 44. As depicted, the wheels 78 are contacting the interior wall of the pipe 44 to guide the pig 74 along the interior of the pipe 44. The nondestructive evaluation tool 94, which may utilize Eddy currents, is positioned near the wall of the pipe 44 to search for flaws or cracks in the pipe. Once the nondestructive evaluation tool 94 detects a flaw, the rotatable sleeve 82 selectively rotates to position the appropriate tool near the flaw. Controllable wheels or other propulsion means may be utilized during the grinding, machining, and welding process to provide longitudinal movement through the pipe. As illustrated, the grinding tool 98, the machining tool 102, and the welding tool 106 are surrounded by boxes 110. In some configurations, only one box is provided that surrounds the grinding tool 98, the machining tool 102, and the welding tool 106. Shapes other than a box may be utilized. In some embodiments, the grinding tool 98, the machining tool 102, and the welding tool 106 extend to contact the interior surface of the pipe 44. For example, the tools may telescope outward until the tools contact the pipe 44.

### EXAMPLES

The following examples are provided for illustrative purposes only and are not intended to limit the scope of the invention.

Experiments were performed to validate the process and apparatus of embodiments of the present invention. Experimental MAWUO welding processes were conducted inside a crude oil media to study the validity of making repairs to an in-service pipeline, tank, and vessel. The experiments assessed (1) the viability of using the hydrocarbon, i.e., crude oil, to form the required plasma shielding for the arc during the welding process, (2) the effect of contained oxygen on the weld, (3) the effects of low oxygen diffusivity, even at elevated temperatures, and (4) fire factors inside an in-service pipeline. Thus, a method of metal arc welding under oil is provided that characterizes welding parameters and also the metallurgical and mechanical effects on the weld integrity. The experiments have also revealed that many factors need to be taken into consideration when using this process to get an acceptable weld, including voltage, current, wire feed, travel speed, bead morphology, and bead dilution. It was found that the weldments were totally martensitic, e.g., a very hard form of crystalline steel structure, when conducted using steel wire. Ni—Fe wires, however, showed better results in managing the hard martinsitic structure through managing the carbon and porosity.

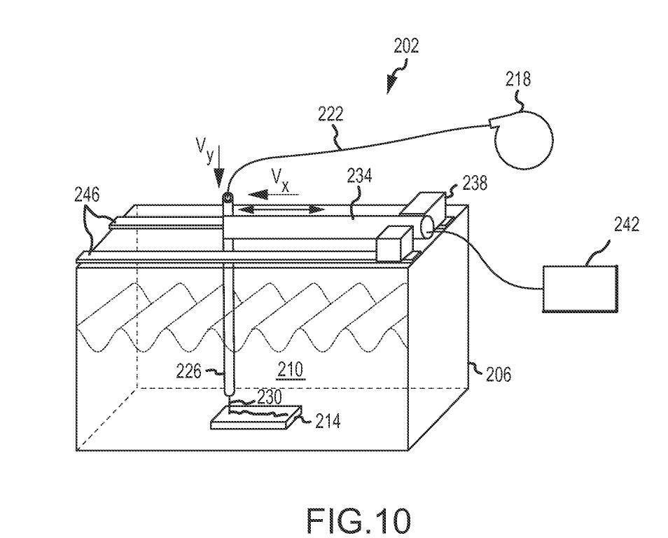

FIG. 10 is a schematic representation of a test fixture 202 used to validate the under-oil welding technique contemplated by various embodiments of the present invention. In one experiment, a tank 206 of crude oil 210 is provided with a steel weld sample 214 positioned therein. A wire feeder 218 continuously feed a consumable electrode wire 222 through a contact tube 226 to maintain close proximity between a tip 230 of the wire electrode 222 and the test sample 214. The contact tube 226 was interconnected to a moving arm 234, which in turn was interconnected to linear actuators 238 and a motor driver 242. The linear actuators 238 rested on racks 246, and thus the linear actuators provided electrode tip 230 movement along the length and width of the tank 206. Data and additional information related to the tests conducted to validate metal arc welding under oil is provided herewith as Example 1 and Example 2. The tests validated that a weld deposit can repair defects in an in-service pipeline, tank, and vessel. Specifically, successful metal transfer through arc welding under a liquid of mixed hydrocarbons is achievable, and can result in weld deposits exhibiting acceptable mechanical properties.

### Example 1

Experiments were conducted according to the test setup depicted in FIG. 10 using steel electrode wires. Voltage, current, wire feed, and linear actuator speed were varied, and the resulting weldments were analyzed to determine if the weld properties met AWS standards. The parameters are summarized in the following table.

TABLE 1
Experiments Using ER70S-6 Steel Wires

| | Linear Actuator | Wire Feed | | Current |
|---|---|---|---|---|
| Weld Sample | Speed (in./min.) | (in./min.) | Voltage (V) | (Amperes) |
| 1 | 2.88 | 205 | 26 | 114 |
| 2 | 4.32 | 200 | 28 | 119 |
| 3 | 4.32 | 200 | 28 | 126 |
| 4 | 4.32 | 230 | 28 | 217 |
| 5 | 4.8 | 230 | 33 | 190 |
| 6 | 7.2 | 200 | 20 | 150 |
| 7 | 7.2 | 200 | 23 | 109 |
| 8 | 7.2 | 200 | 26 | 183 |
| 9 | 7.2 | 230 | 26 | 180 |
| 10 | 7.2 | 230 | 30 | 187 |
| 11 | 7.2 | 200 | 20 | 114 |
| 12 | 7.2 | 200 | 30 | 149 |
| 13 | 7.2 | 220 | 30 | 168 |
| 14 | 7.2 | 215 | 30 | 126 |
| 15 | 7.2 | 220 | 32 | 217 |

Based on the above parameters, weld samples 8 and 15 were acceptable welds. However, in general, the welds made using ER70S-6 grade filler wire showed a high carbon percentage, a high porosity, and a high hardness.

### Example 2

Experiments also were conducted according to the test setup depicted in FIG. 10 using a nickel alloy electrode wire. Voltage, current, wire feed, and linear actuator speed were varied, and the resulting weldments were analyzed to determine if the weld properties met AWS standards. The experiments are summarized in the following table.

TABLE 2
Experiments Using ENiFe-2 Wires

| | Linear Actuator | Wire Feed | | Current |
|---|---|---|---|---|
| Weld Sample | Speed (in./min.) | (in./min.) | Voltage (V) | (Amperes) |
| 1 | 4.32 | 220 | 26.5 | 156 |
| 2 | 4.32 | 260 | 26 | 224 |
| 3 | 4.32 | 300 | 26 | 216 |
| 4 | 4.32 | 300 | 30 | 184 |
| 5 | 4.32 | 260 | 30 | 145 |
| 6 | 4.32 | 260 | 30 | 146 |
| 7 | 4.32 | 300 | 30 | 181 |
| 8 | 4.32 | 350 | 35 | 208 |
| 9 | 7.2 | 340 | 35 | 223 |
| 10 | 7.2 | 360 | 35 | 237 |
| 11 | 7.2 | 390 | 35 | 249 |
| 12 | 7.2 | 420 | 35 | 264 |
| 13 | 7.2 | 420 | 35 | 276 |
| 14 | 7.2 | 400 | 35 | 270 |
| 15 | 7.2 | 440 | 35 | 279 |

Based on the above parameters, weld samples 12 and 13 were acceptable welds. Additionally, in general, the welds made using the ENiFe-2 grade filler wire showed a lower porosity and a lower hardness than the ER70S-6 grade filler wire.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting.

What is claimed is:

1. A method of metal arc welding a submerged workpiece in a liquid hydrocarbon environment using a consumable wire electrode, the method comprising:
forming an arc between the consumable wire electrode and the submerged workpiece in the liquid hydrocarbon environment;
maintaining a substantially constant arc voltage between the consumable wire electrode and the workpiece;
feeding the consumable wire electrode through a contact tube into the arc; and
transferring metal from the consumable wire electrode to the workpiece without the use of an external shielding agent.

2. The method of claim 1, wherein the submerged workpiece comprises at least one of an internal surface of a pipe, a tank, and a vessel.

3. The method of claim 1, wherein the wire electrode comprises an iron-nickel alloy having a nickel content between about 55 to 70 percent of the total wire chemistry by weight.

4. The method of claim 1, wherein the wire electrode comprises a solid wire substantially void of flux.

5. The method of claim 1, wherein the feeding step comprises continuously feeding the wire electrode at a rate between about 200 to 450 inches per minute, and wherein the arc voltage comprises a voltage between about 25 and 38 volts.

6. The method of claim 1, further comprising cleaning the workpiece in preparation for welding a defect in the workpiece.

7. The method of claim 1, further comprising machining the transferred metal to maintain a substantially smooth surface of the workpiece.

8. The method of claim 1, further comprising adjusting the inductance to improve welding behavior.

9. The method of claim 1, further comprising locating an area of the workpiece that needs repair.

10. The method of claim 1, further comprising positioning the wire electrode to a predetermined position before forming the arc.

11. A method of metal arc welding an in-service pipeline using a consumable wire electrode, comprising:
coupling a welding tool to a pipeline pig;
moving the pig through the in-service pipeline to selectively position the welding tool for repair of a defect in a wall of the pipeline;
forming an arc between the consumable wire electrode and the pipeline wall;
maintaining a substantially constant arc voltage between the consumable wire electrode and the pipeline wall;
feeding the consumable wire electrode through a contact tube into the arc;
transferring metal from the consumable wire electrode to the pipeline wall without the use of an external shielding agent to repair the defect; and
removing the pig and welding tool from the in-service pipeline.

12. The method of claim 11, wherein the coupling step comprises interconnecting the welding tool to a sleeve and rotatably coupling the sleeve to the pig.

13. The method of claim 12, further comprising rotating the sleeve to selectively position the welding tool for repair of the defect.

14. The method of claim 12, further comprising rotating the sleeve and moving the pig through the pipeline during the transferring of metal to repair the defect.

15. The method of claim 11, further comprising inspecting the pipeline for defects.

16. The method of claim 11, further comprising cleaning the pipeline to remove debris from the pipeline wall containing the defect.

17. The method of claim 11, further comprising machining the transferred metal to maintain a smooth inner diameter of the pipeline.

18. A pipeline pig adapted for welding a defect within an in-service pipeline, the pipeline pig comprising:
a body adapted for travel within the in-service pipeline;
a welding tool coupled to the body comprising:
a consumable wire electrode;
a contact tube for guiding the wire electrode toward the pipeline wall;
a wire feed unit for feeding the wire electrode through the contact tube; and
a power supply for providing power to the contact tube and the wire feed unit; and
a means for transporting the pipeline pig to a predetermined location within the in-service pipeline.

19. The pipeline pig of claim 18, further comprising wheels coupled to the body for guiding the pig through the pipeline.

20. The pipeline pig of claim 18, wherein the welding tool further comprises a reel for dispensing the wire electrode.

21. The pipeline pig of claim 18, wherein the wire electrode comprises an iron-nickel-manganese alloy having an iron content of about 60 percent, a nickel content of about 20 percent, and a manganese content of about 20 percent of the total wire chemistry by weight.

22. The pipeline pig of claim 18, wherein the welding tool is housed at least partially within the body.

23. The pipeline pig of claim 18, further comprising a sleeve rotatably 100 interconnected to the body.

24. The pipeline pig of claim 23, wherein the welding tool is interconnected to the rotatable sleeve.

25. The pipeline pig of claim 23, wherein the rotatable sleeve comprises a nondestructive evaluation tool, a grinding tool, a welding tool, and a machining tool.

26. The pipeline pig of claim 25, wherein a box is associated with the grinding tool, the welding tool, and the machining tool.

27. The pipeline pig of claim 23, wherein the means for transporting comprise at least one of an onboard pump, a controllable wheel, electric line or wire-line, and a pressure differential within the pipeline.
